(19) United States
(12) Patent Application Publication
(10) Pub. No.: US 2012/0119474 A1
(43) Pub. Date: May 17, 2012

(54) Headliner Mounted Tunable Directional Guide for Curtain Airbag Deployment

(76) Inventors: Chi Li, Farmington Hills, MI (US); Glen Paul Ursaki, Shelby Township, MI (US)

(21) Appl. No.: 12/944,008

(22) Filed: Nov. 11, 2010

(51) Int. Cl. B60R 21/20; B60R 21/16

(52) U.S. Cl. 280/728.3; 280/730.2

(57) ABSTRACT

An airbag assembly in a vehicle including at least one structural support is provided that includes an airbag configured to inflate and an airbag deployment guide. The airbag deployment guide includes a deformable headliner operably associated with the airbag, wherein the deformable headliner is configured to deform based upon an applied force from the inflating airbag and at least one tunable connector operably connecting the deformable headliner to the at least one structural support of the vehicle, wherein the at least one tunable connector is configured to reduce a deformation of the deformable headliner when the inflating airbag contacts the deformable headliner until a threshold force applied to the deformable headliner and the tunable connector by the at least one inflating airbag is exceeded.

### FIELD OF THE INVENTION

The present invention generally relates to an airbag assembly, and more particularly, an airbag assembly including a deployment guide having at least one tunable connector.

### BACKGROUND OF THE INVENTION

Generally, vehicles contain airbags which are deployed during collisions. Typically, the direction the airbag is deployed is based upon the inflation of the airbag and secondary components, which can be configured to guide the direction of the inflating airbag. These secondary devices can include a metal or plastic flange or ramp extending from the headliner area of the vehicle that directs the inflating airbag in a desired direction. However, the metal or plastic ramps can increase the weight of the vehicle, and require an additional manufacturing step to place the metal or plastic ramps in the vehicle.

### SUMMARY OF THE INVENTION

Accordingly, in a first disclosed embodiment, an airbag assembly in a vehicle including at least one structural support is provided that includes an airbag configured to inflate and an airbag deployment guide. The airbag deployment guide includes a deformable headliner operably associated with the airbag, wherein the deformable headliner is configured to deform based upon an applied force from the inflating airbag and at least one tunable connector operably connecting the deformable headliner to the at least one structural support of the vehicle, wherein the at least one tunable connector is configured to reduce a deformation of the deformable headliner when the inflating airbag contacts the deformable headliner until a threshold force applied to the deformable headliner and the tunable connector by the at least one inflating airbag is exceeded.

In another disclosed embodiment, an airbag deployment guide assembly in a vehicle configured to guide an inflating airbag in a predetermined direction by controlling a deformation of a deformable headliner that is configured to deform based upon an applied force from the inflating airbag is provided. The airbag deployment guide assembly includes at least one tunable connector operably connecting the deformable headliner to at least one structural support of the vehicle, wherein the at least one tunable connector is configured to reduce a deformation of the deformable headliner when the inflating airbag contacts the deformable headliner until a threshold force applied to the deformable headliner and the at least one tunable connector by the inflating airbag is exceeded, such that the reduced deformation of the deformable headliner is based upon the connection to the at least one structural support of the vehicle by the at least one tunable connector until the at least one tunable connector releases the deformable headliner.

In another disclosed embodiment, a vehicle is provided that includes an airbag, a structural support, a hook and loop fastener connected to the structural support, and a deformable headliner operably connected to the fastener, the fastener configured to reduce a deformation of the headliner when the airbag inflates, and the headliner configured to guide a direction of the inflating airbag until the fastener releases the headliner.

These and other aspects, objects, and features of the present invention will be understood and appreciated by those skilled in the art upon studying the following specification, claims, and appended drawings.

### BRIEF DESCRIPTION OF DRAWINGS

In the drawings:

FIG. 1 is a perspective view of a pillar in a vehicle having an attachment bracket, and a headliner between the pillar and the attachment bracket, in accordance with one embodiment of the present invention;

FIG. 2 is a perspective view of a pillar in a vehicle with an attachment bracket removed, and a tunable connector on a headliner, in accordance with one embodiment of the present invention;

FIG. 3 is a perspective view of an attachment bracket having a tunable connector, in accordance with one embodiment of the present invention;

FIG. 4A is an environmental view of an airbag assembly in a vehicle being deployed at a particular time during a deployment process, according to the prior art;

FIG. 4B is an environmental view of an airbag assembly in a vehicle being deployed at the same time during a deployment process of FIG. 4A, and guided by an airbag deployment guide, in accordance with one embodiment of the present invention;

FIG. 5A is an environmental view of an airbag assembly in a vehicle being deployed at a particular time during a deployment process, according to the prior art; and

FIG. 5B is an environmental view of an airbag assembly in a vehicle being deployed at the same time during a deployment process of FIG. 5A, and guided by an airbag deployment guide, in accordance with one embodiment of the present invention.

### DETAILED DESCRIPTION OF PREFERRED EMBODIMENTS

As required, detailed embodiments of the present invention are disclosed herein; however, it is to be understood that the disclosed embodiments are merely exemplary of the invention that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present invention.

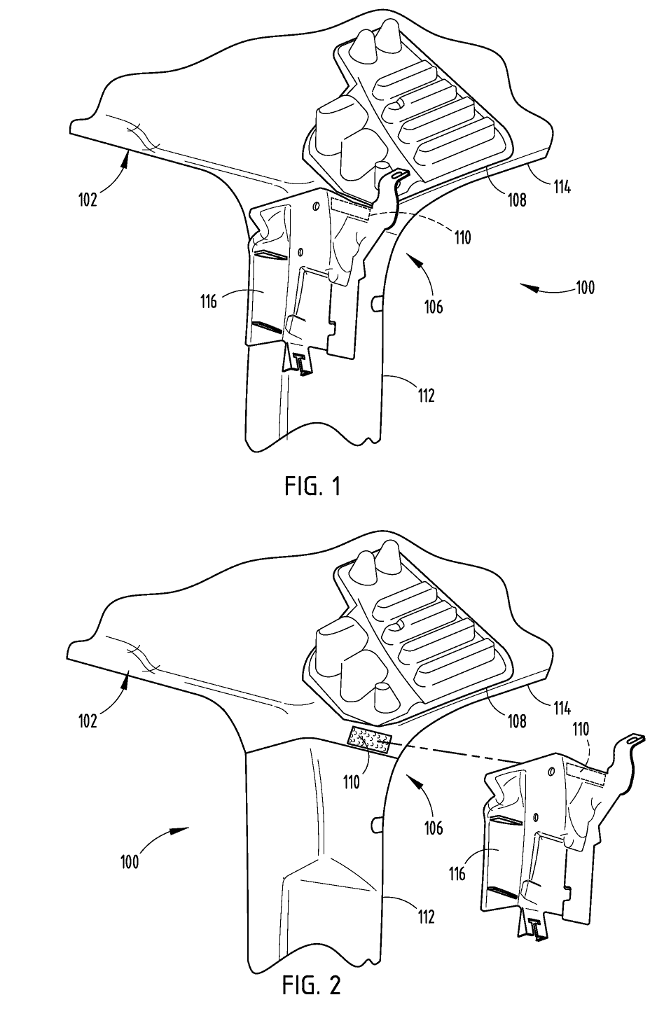

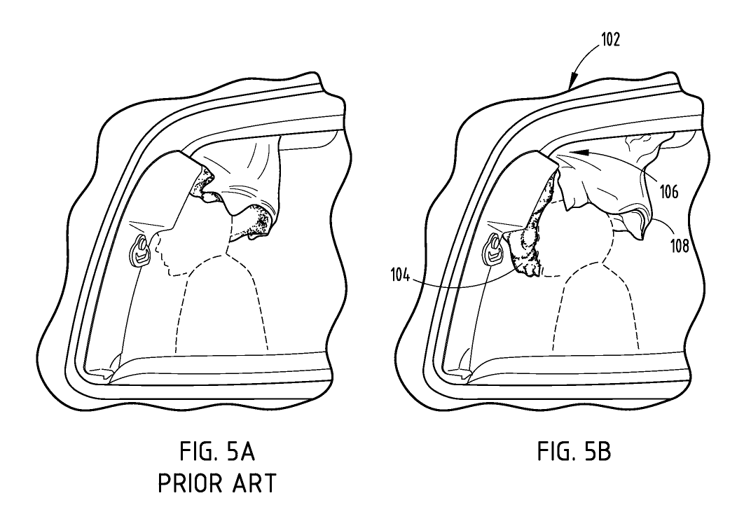

With respect to FIGS. 1-3, 4B, and 5B an airbag assembly is generally shown at reference identifier 100 (FIGS. 1 and 2). The airbag assembly 100 is typically in a vehicle, which is generally indicated at reference identifier 102. The airbag assembly 100 can include an airbag 104 (FIGS. 4B and 5B) that is configured to inflate, and an airbag deployment guide, which is generally indicated at reference identifier 106 (FIGS. 1, 2, 4B, and 5B). The airbag deployment guide 106 can include a deformable headliner 108 (FIGS. 1, 2, 4B, and 5B) operably associated with the airbag 104, wherein the deformable headliner 108 is configured to deform based upon an applied force from the inflating airbag 104. The airbag deployment guide 106 further includes at least one tunable connector 110 (FIGS. 1-3) operably connecting the deformable headliner 108 to at least one structural support of the vehicle 102. The tunable connector 110 can be configured to reduce a deformation of the deformable headliner 108 when the inflating airbag 104 contacts the deformable headliner 108 to a threshold force applied to the deformable headliner 108 and the at least one tunable connector 110 by the inflating airbag 104 is exceeded, as described in greater detail herein.

For purposes of explanation and not limitation, the tunable connector 110 connecting the deformable headliner 108 to the structural support of the vehicle 102 provides additional rigidity to the deformable headliner 108. Thus, the deformable headliner 108 does not deform at as quick of a rate as if the tunable connector 110 was not included in the airbag deployment guide 106. In other words, the tunable connector 110 reduces the amount of deformation of the deformable headliner 108 when the inflating airbag 104 first contacts the deformable headliner 108, and once the tunable connector 110 is released due to the threshold force being exceeded, the deformable headliner 108 deforms at the quicker rate based upon the characteristics of the deformable headliner 108 (e.g., less rigidity). However, during the period of time that the tunable connector 110 is connected to the deformable headliner 108 and the structural support of the vehicle 102, the deformable headliner 108 can be positioned to direct the airbag 104 in a desirable direction. Therefore, the tunable connector 110 can enhance the rigidity of the deformable headliner 108 when connected thereto and the structural support so that the deformable headliner 108 can be positioned to guide the inflating airbag 104 in a desired direction (e.g., front-to-rear direction), and then once the airbag 104 is adequately inflated and directed, the tunable connector 110 can release the deformable headliner 108, such that the deformable headliner 108 deforms at a quicker rate due to the applied force from the inflating airbag 104.

According to one embodiment, the deformable headliner 108 can be configured to guide the airbag 104 in a predetermined direction during inflation of the airbag 104 as a result of a reduced deformation of the deformable headliner 108 based upon the connection to the at least one structural support of the vehicle 102 by the tunable connector 110. Thus, the tunable connector 110 can be configured to substantially maintain the deformable headliner 108 in a desirable position and/or a desirable shape as the airbag 104 is initially inflating, so that the deformable headliner 108 can guide the airbag 104 in a predetermined direction. For an airbag 104 being deployed from a headliner area in front of a driver, the desired direction the deformable headliner 108 guides the inflating airbag 104 is a front-to-rear direction when the deformable headliner 108 is connected to the structural support by the tunable connector 110. It should be appreciated by those skilled in the art that the airbag assembly 100 can include airbags 104 at other locations within the vehicle 102, such as, but not limited to, a side airbag, wherein the deformable headliner 108 (or other deformable vehicle component) and the tunable connector 110 directs the inflating airbag 104 in another desirable direction.

In accordance with one exemplary embodiment, the tunable connector 110 can be configured to substantially prevent movement of the deformable headliner 108 during the first approximately five to fifteen milliseconds (5-15 ms) of airbag 104 inflation. Such a period of time, wherein the deformation of the deformable headliner 108 is reduced or approximately eliminated, allows for the deformable headliner 108 to adequately guide the inflating airbag in a desirable direction, as compared to an airbag system that does not include the tunable connector, wherein the deformable headliner is immediately deformed at the time airbag inflation is initiated. Thus, the rigidity of the deformable headliner 108 is dynamically changed during the airbag 104 inflation process, such that the deformable headliner 108 has a first rigidity during a first inflation time period and can guide the inflating airbag 104, and the deformable headliner 108 can have a second (lesser) rigidity during a second inflation time period.

With respect to FIGS. 4A and 4B, these figures illustrate a prior art airbag assembly (FIG. 4A) at a particular time during a deployment process, and the airbag assembly 100 (FIG. 4B) at the same particular time during a deployment process. The particular time, can be approximately twenty-one milliseconds (21 ms) after the start of the deployment process. As illustrated in FIG. 4A, the headliner has more deformity at this time during the deployment process, and thus, is less capable of guiding the inflating airbag, whereas, as illustrated in FIG. 4B, the deformable headliner 108 is less deformable during a first part of the deployment process due to the tunable connector 110, and guides the inflating airbag 104 in a desirable direction.

As to FIGS. 5A and 5B, these figures illustrate a prior art airbag assembly (FIG. 5A) at a particular time during a deployment process, and the airbag assembly 100 (FIG. 5B) at the same particular time during a deployment process. The particular time during the deployment process illustrated in FIGS. 5A and 5B is a time later in the deployment process than FIGS. 4A and 4B. As illustrated in FIG. 5A, the headliner has more deformity at this time during the deployment process, and thus, is less capable of guiding the inflating airbag, whereas, as illustrated in FIG. 5B, the deformable headliner 108 is less deformable during a first part of the deployment process due to the tunable connector 110, and guides the inflating airbag 104 in a desirable direction. Thus, due to the increased deformity of the headliner illustrated in FIG. 5A, the inflating airbag is deployed on top of the passenger's (or driver's) head, rather than the airbag 104, as illustrated in FIG. 5B, being guided to inflate and deploy at least partially in front of the passenger (or driver).

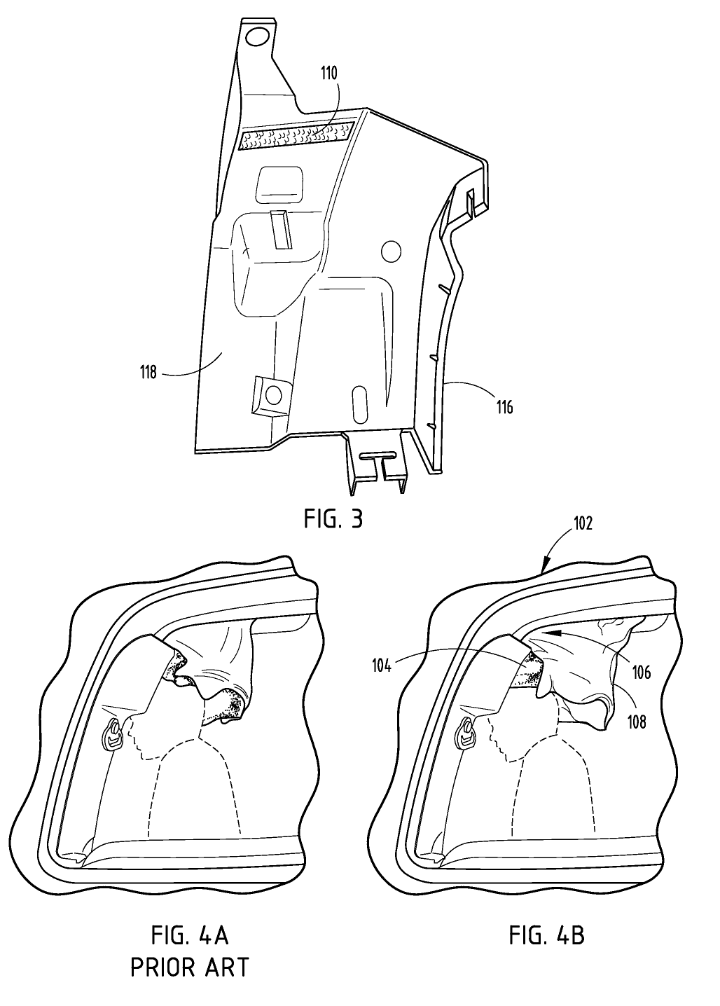

The at least one structural support of the vehicle 102 can include a pillar 112, a headliner support 114, the like, or a combination thereof, according to one embodiment. Typically, the pillar 112 includes an attachment bracket 116 that connects to the pillar 112, such that a portion of the deformable headliner 108 is between the pillar 112 and the attachment bracket 116 (FIG. 1). In such an embodiment, a first part of the tunable connector 110 (e.g., a female part) can be on an interior side 118 of the attachment bracket 116 (FIG. 3), and a second part of the tunable connector 110 (e.g., a male part) can be on an exterior (or viewable) side of the portion of the deformable headliner 108 that is between the pillar 112 and the attachment bracket 116 (FIG. 2). The attachment bracket 116 can be connected to the pillar 112 using various suitable forms of mechanical attachment, such as, but not limited to, press-fit/friction-fit, nut-and-bolt, rivet, fastener device, adhesive, the like, or a combination thereof.

By way of explanation and not limitation, the pillar 112 can be the vehicle's 102 A-pillar, B-pillar, C-pillar, D-pillar, or the like. Additionally or alternatively, the headliner support 114 can be a roof support extending laterally along a roof of the vehicle 102. It should be appreciated by those skilled in the art that the vehicle 102 can include one or more airbag assemblies 100 in various locations of the vehicle 102.

Typically, the at least one tunable connector includes two tunable connectors 110 being included in the airbag deployment guide 106, such that a first tunable connector 110 is attached to the pillar 112 of the vehicle 102 and operably connected to the deformable headliner 108, and a second tunable connector 110 is attached to the headliner support 114 of the vehicle 102 and operably connected to the deformable headliner 108. Increasing the number of tunable connectors 110 included in the deployment guide 106 increases the rigidity of the deformable headliner 108 until the tunable connectors 110 release or otherwise become disconnected from the deformable headliner 108 and/or the support structure of the vehicle 102. It should be appreciated by those skilled in the art that the structural supports of the vehicle 102 can be other suitable supports of the vehicle.

According to one embodiment, the tunable connector 110 is a hook and loop fastener (e.g., VELCRO™). Thus, different strength hook and loop fasteners can be utilized in the deployment guide 106, such that the deployment guide 106 is tunable based upon other features of the vehicle 102, such as, but not limited to, inflation forces of the airbag 104, a friction connection (e.g., strength) of the two parts of the hook and loop fastener, and the deformation characteristics of the deformable headliner 108. It should be appreciated by those skilled in the art that other suitable connectors can be used as the tunable connector 110.

Typically, the reduced deformation of the deformable headliner 108 can be a function of a rigidity of the deformable headliner, a strength of the tunable connector 110, the like, or a combination thereof. Additionally or alternatively, only the deformable headliner 108 guides a direction of the airbag during inflation of the airbag 104. Thus, a secondary device, such as a metal or plastic ramp does not need to be inserted into the vehicle 102 to direct the airbag during inflation. Therefore, a weight of the vehicle 102 is reduced by not having this additional component, and a manufacturing step is reduced, since a secondary component is not inserted into the vehicle 102 for the sole purpose of guiding the direction of the airbag 104.

Advantageously, the airbag assembly 100 can dynamically alter a rigidity of the deformable headliner 108 during airbag 104 inflation, such that the deformable headliner 108 is positioned to guide the inflating airbag 104 in a desirable direction. The airbag assembly 100 can also be configured to guide the inflating airbag 104 in a desirable direction without requiring secondary components that are solely used for guiding the inflating airbag 104. It should be appreciated by those skilled in the art that the airbag assembly 100 can have additional or alternative advantages not explicitly described herein. It should further be appreciated by those skilled in the art that the above-described components can be combined in additional or alternative ways not explicitly described herein.

It is to be understood that variations and modifications can be made on the aforementioned structure without departing from the concepts of the present invention, and further it is to be understood that such concepts are intended to be covered by the following claims unless these claims by their language expressly state otherwise.

We claim:

1. An airbag assembly in a vehicle comprising at least one structural support, said airbag assembly comprising:
an airbag configured to inflate; and
an airbag deployment guide comprising:
a deformable headliner operably associated with said airbag, wherein said deformable headliner is configured to deform based upon an applied force from said inflating airbag; and
at least one tunable connector operably connecting said deformable headliner to the at least one structural support of the vehicle, wherein said at least one tunable connector is configured to reduce a deformation of said deformable headliner when said inflating airbag contacts said deformable headliner until a threshold force applied to the deformable headliner and said at least one tunable connector by said inflating airbag is exceeded.

2. The airbag assembly of claim 1, wherein said deformable headliner is configured to guide said airbag in a predetermined direction during inflation of said airbag as a result of said reduced deformation of said deformable headliner based upon said connection to the at least one structural support of the vehicle by said at least one tunable connector.

3. The airbag assembly of claim 1, wherein the at least one structural support of the vehicle comprises a pillar.

4. The airbag assembly of claim 1, wherein the at least one structural support of the vehicle comprises a headliner support.

5. The airbag assembly of claim 1, wherein said at least one tunable connector operably connecting said deformable headliner to the at least one structural support comprises a first tunable connector attached to a pillar of the vehicle and operably connected to said deformable headliner, and a second tunable connector attached to a headliner support of the vehicle and operably connected to said deformable headliner.

6. The airbag assembly of claim 1, wherein said tunable connector is a hook and loop fastener.

7. The airbag assembly of claim 1, wherein said reduced deformation of said deformable headliner is a function of a rigidity of said deformable headliner and a strength of said at least one tunable connector.

8. The airbag assembly of claim 1, wherein only said deformable headliner guides a direction of said airbag during inflation of said airbag.

9. An airbag deployment guide assembly in a vehicle configured to guide an inflating airbag in a predetermined direction by controlling a deformation of a deformable headliner that is configured to deform based upon an applied force from the inflating airbag, said airbag deployment guide comprising:
at least one tunable connector operably connecting the deformable headliner to at least one structural support of the vehicle, wherein said at least one tunable connector is configured to reduce a deformation of the deformable headliner when the inflating airbag contacts the deformable headliner until a threshold force applied to the deformable headliner and said at least one tunable connector by said inflating airbag is exceeded, such that said reduced deformation of the deformable headliner is based upon said connection to said at least one structural support of the vehicle by said at least one tunable connector until said at least one tunable connector releases the deformable headliner.

10. The airbag assembly of claim 9, wherein said at least one structural support of the vehicle comprises a pillar.

11. The airbag assembly of claim 9, wherein said at least one structural support of the vehicle comprises a headliner support.

12. The airbag assembly of claim 9, wherein said at least one tunable connector operably connecting the deformable headliner to at least one structural support comprises a first tunable connector attached to a pillar of the vehicle and operably connected to the deformable headliner, and a second tunable connector attached to a headliner support of the vehicle and operably connected to the deformable headliner.

13. The airbag assembly of claim 9, wherein said at least one tunable connector is a hook and loop fastener.

14. The airbag assembly of claim 9, wherein said reduced deformation of the deformable headliner is a function of a rigidity of the deformable headliner and a strength of said at least one tunable connector.

15. The airbag assembly of claim 9, wherein only the deformable headliner guides a direction of the airbag during inflation of the airbag.

16. A vehicle comprising
an airbag;
a structural support;
a hook and loop fastener connected to said structural support; and
a deformable headliner operably connected to said fastener, said fastener configured to reduce a deformation of said headliner when said airbag inflates, and said headliner configured to guide a direction of said inflating airbag until said fastener releases said headliner.

17. The vehicle of claim 16, wherein said at least one structural support of the vehicle comprises a pillar.

18. The vehicle of claim 16, wherein said at least one structural support of the vehicle comprises a headliner support.

19. The vehicle of claim 16, wherein said hook and loop fastener operably connecting said headliner to said structural support comprises a first fastener attached to a pillar of the vehicle and operably connected to said headliner, and a second fastener attached to a headliner support of the vehicle and operably connected to said headliner.

20. The airbag assembly of claim 16, wherein said reduced deformation of said headliner is a function of a rigidity of said headliner and a strength of said fastener.
